(19) United States
(12) Patent Application Publication
(10) Pub. No.: US 2006/0139402 A1
(43) Pub. Date: Jun. 29, 2006

(54) Printing system

(75) Inventor: Yoshinori Nakashima, Osaka-shi (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/317,019

(22) Filed: Dec. 27, 2005

(30) Foreign Application Priority Data
Dec. 27, 2004 (JP) 2004-376657

(51) Int. Cl. B41J 2/15

(52) U.S. Cl. 347/40

(57) ABSTRACT

A DSC 10 compares number of objects to be printed in a printing job set by itself to number of objects that have already been printed on a single printing paper described in a printing state notice issued from a printer 30 with respect to the DSC 10 to thereby calculate and retain number of the printing objects to be set in the printing job, and issues the printing job in which the calculated number of the objects to be printed is set when the printing process is executed next.

### BACKGROUND OF THE INVENTION

1. Field of the Invention

The present invention relates to a printing system that can be incorporated into a device such as a PictBridge-capable imaging and printing device (for example, digital still camera and printer).

2. Description of the Related Art

Along with the development of a technology for digital appliances, an individual user can now readily print an image he/she obtained using a digital still camera (hereinafter, referred to as DSC), a printer and a personal computer (PC).

If the DSC and the printer support a direct printing function which realizes the printing process through a direct connection via an interface such as USB (universal serial bus), in particular, the user is not required to possess the PC to print the image. Therefore, the photographic printing directly conducted by the individual user is increasingly widespread. For the outline of the USB, see “Universal Serial Bus Specification Revision 2.0”, Compaq/Hewlett-Packard/Intel/Microsoft/Philips, Apr. 27, 2000.

The direct printing function includes a few systems, a typical example of which is the PictBridge standardized in the Camera & Imaging Products Association (CIPA). The outline of the PictBridge protocol is recited in “White Paper of CIPA-DC-001-2003 Digital Photo Solutions for Imaging Devices”, CIPA, Feb. 3, 2003.

For example, No. 2004-23304 of the Publication of the Unexamined Japanese Patent Applications discloses a printing system in which the DSC and the printer are functionally coupled with each other via the USB so that an image to be printed is selected and a printing layout is set on the DSC side, and number of copies to be printed is set on the printer side.

The DSC and the printer supporting the Pictbridge protocol can basically realize the direct printing function based on an optional combination.

However, in the specifications of the Pictbridge protocol and the like, a control mode of a print-controlled region beyond the definitions of the specifications relies on a design intent of a relevant vendor, that is a manufacturer of the DSC and the printer. Therefore, there is practically such a case where only a part of the printing function originally included in the DSC or the printer can be used depending on the details of the respective control modes installed in the DSC and the printer by the different vendors.

For example, when an index printing is executed in a printing system where the DSC and the printer supporting the PictBridge are connected, the number of the images allocated to each printing paper is set depending on the control mounting mode in the printer. To describe the index printing mentioned above, a plurality of images is allocated to the printing paper by n images (n is a natural number of at least 1) each and disposed in parallel on the printing paper, and then printed.

However, an object to be printed is designated by the DSC in the index printing operation. Further, number of the objects to be printed set in a single printing job also relies on the implementation of the control software for the DSC. The object to be printed represents an image file according to the JPEG format, TIFF format or the like designated as a printing object and incorporated in the DSC or stored in an external recording medium. Because the number of copies (default value is 1) can be designated in each image file and the files of n number of types can be designated as the printing object, number of printing objects when the image files of the n number of types are designated as the printing object can be expressed as follows.

$${\sum }_{k = 1}^{n} m ( k )$$

(m(k) is the number of copies of the kth image file) Further, the single printing job represents a unit based on which the printing process from the DSC is executed with respect to the printer. The printer executes the printing process in accordance with the number of the printing objects, number of copies of the printing objects, printing layout and the like designated in a printing job from the DSC.

Therefore, when the index printing is executed in a state where a maximum value of the number of the images that can be designated by the DSC in the single printing job is smaller than the number of the images allocated in each printing paper by the printer in the execution of the index printing, the following problems are generated.

In the foregoing state, the page feed is generated in each printing job. Further, a result of the printing job includes a useless blank space because the number of the images actually allocated to a single page is less than the number of the images that can be normally printed by the printer. It cannot be said that a printing capacity originally possessed by the printer was fully utilized in the foregoing printing result, which leaves problems both in terms of printing costs and end result.

### SUMMARY OF THE INVENTION

Therefore, a main object of the present invention is, in a printing system where there can be a plurality of combinations of printing services and printing clients, to exploit a printing layout capacity included in an optional combination and optimize a printing result provided that a certain compatibility is guaranteed.

A printing client according to the present invention is a printing client connected to a printing server for executing a printing process in which a maximum number of images n (n is a natural number of at least 1) are printed on each printing paper in such manner that an intercommunication therebetween is allowed and notified of a printing state of the printing process by the printing server, the printing client outputting a printing instruction for dividing entire groups of images including m number of images defined in the following expression into first groups of images having p number of images and q number of groups and a second group of images having r number of images and one or none group and printing the respective divided images on the each printing paper,
m=p*q+r*s
p is a natural number not including 0
r satisfies p>r
s=0 or 1
q, r are natural numbers including 0,

wherein the maximum number of the images n per the printing paper is calculated from the printing state notified by the printing server, and the number of the images in the first groups of images p is changed based on the comparison of the calculated maximum number of the images n to the number of the images in the first groups of images p set in the printing client, and the entire groups of images are divided into the first groups of images and the second group of images based on a changed number of images in the first groups of images p′ at a next time when the printing is instructed.

A printing server according to the present invention connected to a printing client for outputting a printing instruction for dividing entire groups of images including m number of images defined in the following expression into first groups of images having p number of images and q number of groups and a second group of images having r number of images and one or none group and printing the respective divided images on each printing paper in such manner that an intercommunication therebetween is allowed, the printing server further executing a printing process in which n number of images (n is a natural number of at least 1) are printed per the printing paper based on the printing instruction,
m=p*q+r+s
p is a natural number not including 0
r satisfies p>r
s=0 or 1
q, r are natural numbers including 0,

wherein the printing server dynamically sets number of images to be printed on the each printing paper n′ (n′<=n) based on the printing instruction received from the printing client and executes the printing process.

According to the present invention, the number of objects to be printed (the number of the images in the first groups of images p) set in the printing job issued by the printing client can be changed in accordance with the number of objects to be printed (the maximum number of the images n in each printing paper) per a single printing page different for each printing server. As a result, an optimum printing layout can be realized in the printing process in each printing server.

According to the printing system of the present invention comprising the printing server and the printing client, in the printing system where there can be the plurality of combinations of printing services and printing clients, the printing layout capacity included in the optional combination can be exploited and the printing result can be optimized without utilizing any special protocol such as a vendor unique command, while a compatibility with a standard protocol is being assured at the same time.

According to the printing system of the present invention comprising the printing server and the printing client, the number of the objects to be printed set in the printing job issued by the printing client can be dynamically changed in accordance with the number of the objects to be printed in each printing page different for each printing server. Therefore, the present invention is suitable for an application in which it is necessary to adjust to a plurality of printing layouts different for each device in an environment where a usable memory capacity is limited such as an embeded system.

### BRIEF DESCRIPTION OF THE DRAWINGS

These and other objects as well as advantages of the invention will become clear by the following description of preferred embodiments of the invention. A number of benefits not recited in this specification will come to the attention of the skilled in the art upon the implementation of the present invention.

FIG. 1 is a block diagram of a printing system according to embodiments 1-4 of the present invention.

FIG. 2 shows processing steps of the printing system according to the embodiment 1.

FIG. 3 shows a first state of a printing result according to the embodiment 1.

FIG. 4 shows a second state of the printing result according to the embodiment 1.

FIG. 5 shows a first state of a printing result according to a modified embodiment of the embodiment 1.

FIG. 6 shows a second state of the printing result according to the modified embodiment of the embodiment 1.

FIG. 7 shows processing steps of the printing system according to the embodiment 2.

FIG. 8 shows a printing result according to the embodiment 2.

FIG. 9 shows processing steps of the printing system according to the embodiment 3.

FIGS. 10 are reference drawings of a printing result according to the embodiment 3.

FIG. 11 shows a printing result according to the embodiment 3.

FIG. 12 shows processing steps of the printing system according to the embodiment 4.

FIG. 13 is a reference drawing of a printing result according to the embodiment 4.

FIG. 14 shows the printing result according to the embodiment 4.

### DETAILED DESCRIPTION OF THE INVENTION

Hereinafter, preferred embodiments of the present invention are described referring to the drawings.

### Embodiment 1

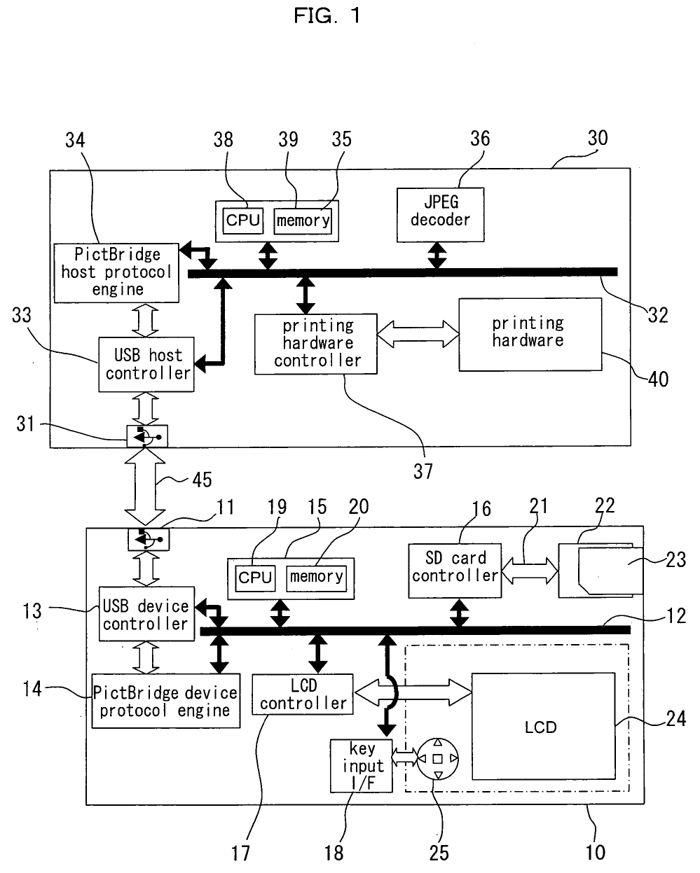

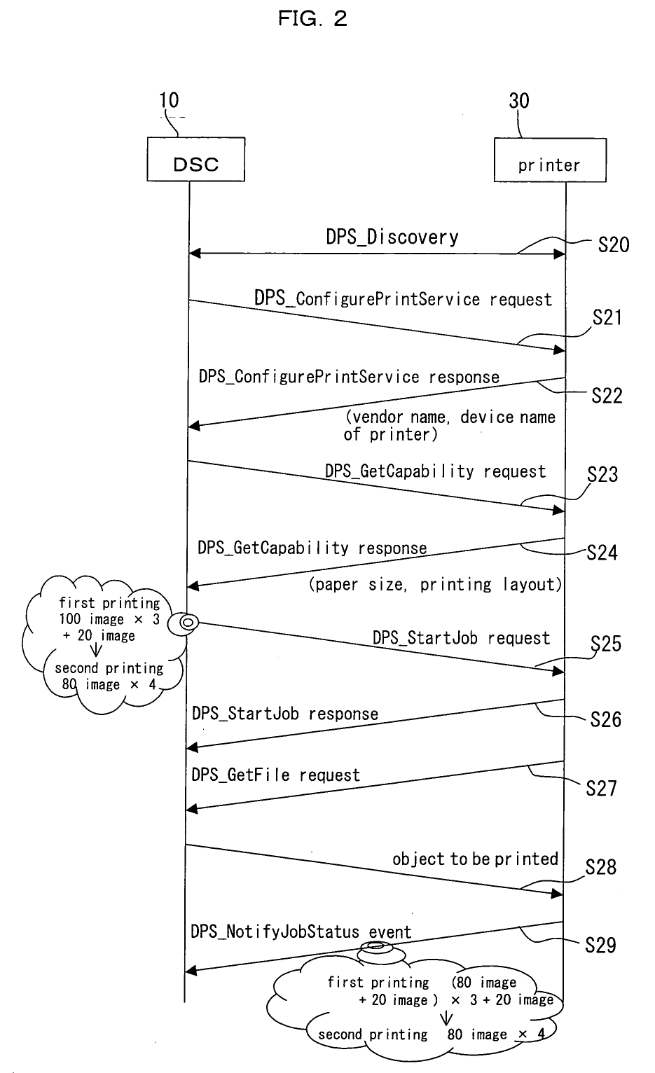

A preferred embodiment 1 of the present invention is described referring to FIGS. 1 and 2. FIG. 1 is a block diagram of a printing system, and FIG. 2 shows processing steps of the printing system.

In FIG. 1, the printing system comprises a block constituting a digital still camera (DSC) 10 and a block constituting a printer 30 which are connected via a USB cable 4 in such manner that an intercommunication is allowed. In the present embodiment, the DSC 10 constitutes a printing client, while the printer 30 constitutes a printing server.

The DSC 10 comprises a USB device controller 13 connected to a USB-B receptacle 11 and a CPU bus 12, a PictBridge device protocol engine 14, a system controller 15, a SD card controller 16, an LCD controller 17, a key input I/F 18, a CPU 19 and a memory 20 constituting a system controller 15, a SD memory card slot 22 connected to the SD card controller 16 via a SD bus 21, a SD memory card (trade mark) 23 attached in the SD memory card slot 22, an LCD 24 connected to the LCD controller 17, and an arrow key 25 connected to the key input I/F 18.

The printer 30 comprises a USB host controller 33 connected to a USB-A receptacle 31 and a CPU bus 32, a PictBrdige host protocol engine 34, a system controller 35, a JPEG decoder 36, a printing hardware controller 37, a CPU 38 and a memory 39 constituting a system controller 35, and a printing hardware 40 connected to the printing hardware controller 37.

Below is described a printing process in the printing system comprising the foregoing components. First, an initial connection sequence (enumeration) between the USB host controller 33 and the USB device controller 13 is executed. When the enumeration is executed and the sequence thereof is established, a plurality of logical communication paths (pipes) is established on a signal in the USB bus 45 as a serial bus, which allows a USB protocol communication.

In the USB protocol, various functions can be realized depending on what kind of the pipes is configured and how commands communicated via the pipes are set. In the embodiment 1, a USB image class is established via three pipes, which are a bulk-in pipe, a bulk-out pipe and an interrupt-in pipe, and a picture transfer protocol (PTP) is used in setting the commands. In other words, the printer 30 is operated as a USB image class host, and the DSC 10 is operated as a USB image class device.

When the picture transfer protocol communication (PTP communication) is established, a communication based on the PictBridge protocol is allowed between the PictBridge host protocol engine 34 and the PictBridge device protocol engine 14 via the commands set based on the PTP. The printer 30 and the DSC 10 respectively serve as the printing server and the printing client via the PictBridge protocol.

Next, a specific printing operation via the PictBridge protocol is described referring to FIGS. 1-3.

When the mutual confirmation that the printer 30 and the DSC 10 are both the Pictbridge-capable devices (DPS_Discovery) is completed (S20), the PictBridge device protocol engine 14 issues an activating command of the printing service (DPS_ConfigurePrintService Request) to the PictBridge host protocol engine 34 (S21).

The PictBridge host protocol engine 34 receives the DPS_ConfigurePrintService Request and correspondingly notifies the system controller 35 of the reception of the command. The system controller 35 makes an inquiry about a state of the printing hardware 40 via the hardware controller 37. The system controller 35 notifies the PictBridge host protocol engine 34 that the printing service can be offered when the printing hardware 40 is in a printable state.

The PictBrdige host protocol engine 34 receives the notification and correspondingly issues a DPS_ConfigurePrintService Response to the PictBridge device protocol engine 14 to thereby notify that the printing service is available (S22). At that time, a vendor name and a device name of the printer 3 are communicated together with the state of the printing service. Therefore, the system controller 15 acquires the vendor name and the device name from the PictBridge device protocol engine 14 and stores them in the memory 20.

When the DPS_ConfigurePrintService Request—Response is completed, the PictBridge device protocol engine 14 issues a printer capability acquiring command (DPS_GetCapability Request) to the PictBridge host protocol engine 34 (S23). The PictBridge host protocol engine 34 receives the DPS_GetCapability Request and correspondingly issues a DPS_GetCapability Response to the PictBridge device protocol engine 14 to thereby notify an information such as a paper size, printing layout and the like to be supported in accordance with a parameter of the request (S24).

In the embodiment 1, the printer 30 at least supports the paper size of A4, and further, an index printing in which the maximum number of the images that can be printed on each printing paper is n. The system controller 15 acquires the information from the PictBridge device protocol engine 14 and stores them in the memory 20.

When the DPS_GetCapability Request—Response is thus completed, the DSC 10 displays a printing menu screen on the LCD 24 in such manner that the capability of the printer 30 is reflected to thereby lead a user to perform an input operation. The user watches the printing menu screen displayed on the LCD 24 and operates the arrow key 25 to thereby select the printing process. In the embodiment 1, the entire-image index printing is executed on the A4 sheet of paper.

When the entire-image index printing is executed in the DSC 10 based on the user's operation, the PictBridge device protocol engine 14 issues a printing job issuing command (DPS_StartJob Request) to the PictBridge host protocol engine 34 (S25).

At that time, the PictBridge device protocol engine 14 should describe the entire images recorded on the SD memory card 23 together with the paper size (A4) and the printing layout (index printing) on an object to be printed as a parameter to be described in the DPS_StartJob Request. However, restrictions of the memory and the like impose an upper limit on a size of the DPS_StartJob Request. Therefore, when it is not possible to describe the entire images in a single DPS_StartJob Request, the single DPS_StartJob Request is issued a plurality of times so that the index printing of the entire images recorded on the SD memory card 23 can be realized.

More specifically, the PictBridge device protocol engine 14 outputs a printing instruction (DPS_StartJob Request) for dividing entire groups of images including m number of images defined in the following expression (all of the images recorded on eh SD memory card 23) and the number of the copies of the each image into first groups of images having p number of images and q number of groups and a second group of images having r number of images and one or none group and printing the respective divided images on each printing paper to the PictBridge Host protocol engine 34.
m=p*q+r*s
p is a natural number not including 0
r satisfies p>r
s=0 or 1
q, r are natural numbers including 0

In the embodiment 1, the PictBridge device protocol engine 14 sets the maximum value of the number of the images in the object to be printed that can be described in the single DPS_StartJob Request (the number of the images in the first groups of images p) to 100 images, and sets the number of all of the image objects recorded on the SD memory card 23 (the number of the images in the entire groups of images m) to 320 images. In order to realize the entire-image index printing in the foregoing example, the DPS_StartJob Request is issued four times (100 images+100 images+100 images+20 images=320 images in total). Then, the number of the images in the first groups of images p is 100, the number of the groups in the first groups of images q is 3, the number of the images in the second group of images r is 20, and the number of the groups in the second group of images s is 1.

The PictBridge host protocol engine 34 of the printer 30, in response to the reception of the DPS_StartJob Request from the DSC 10, analyzes the contents of the request and issues the DPS_StartJob Response to the PictBridge device protocol engine 14 of the DSC 10 (S26). Further, the PictBridge host protocol engine 34 issues the DPS_GetFile Request to the PictBridge device protocol engine 14 (S27) to thereby acquire the image object to be printed from the DSC 10 (S28).

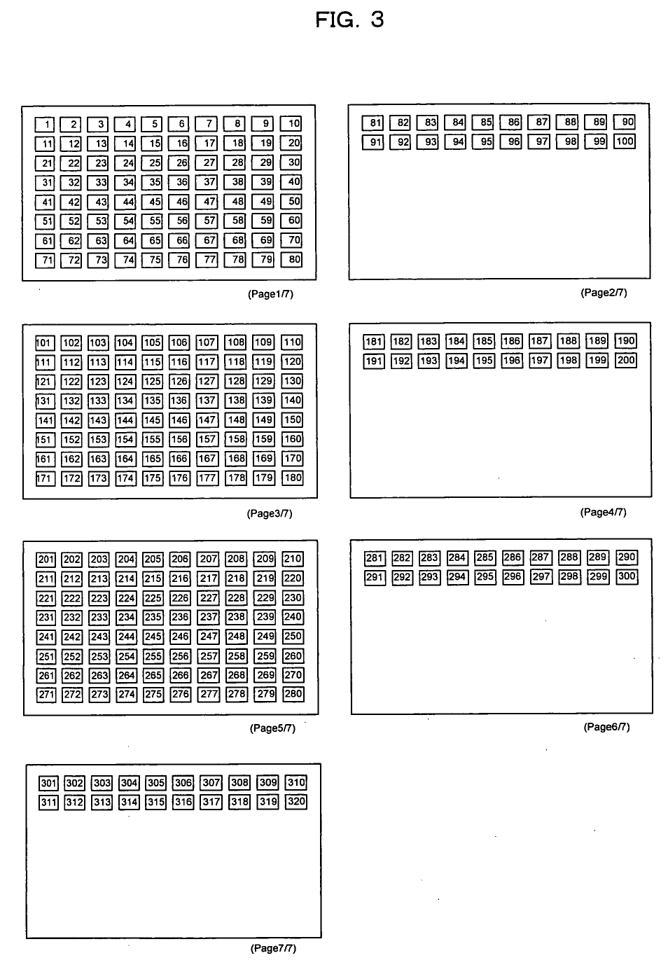

Provided that the maximum number of the images n (n is a natural number of at least 1) allocated to each printing paper by the printer 30 is 80 (80 images per page) in the case where the printing type (layout) is the index printing and the paper size in the printer 30 is A4, when, for example, the DPS_StartJob Request in which the 100 image objects (the number of the images in the first groups of images p is 100) are described is made to the printer 30 from the DSC 10, the printer 30 takes each DPS_StartJob Request as a request for executing the printing job in a manner of dividing into two pages and executes the printing job (80 images in the first page, 20 images in the second page, 100 images in total). Therefore, a printing result obtained in the foregoing entire-image index printing is, as shown in FIG. 3, extends into seven pages (80 images in the first page, 20 images in the second page, 80 images in the third page, 20 images in the fourth page, 80 images in the fifth page, 20 images in the sixth page, 20 images in the seventh page).

A printing progress notice (DPS_NotifyJobStatus Event) at that time shows [first printing]: (Page 1/2, 80 images have been printed), [second printing]: (Page 2/2, 100 images have been printed), [third printing]: (Page 1/2, 80 images have been printed), [fourth printing]: (Page 2/2, 100 images have been printed), [fifth printing]:(Page 1/2, 80 images have been printed), [sixth printing]:(Page 2/2, 100 images have been printed), [seventh printing]: (Page 1/1, 20 images have been printed). As a result, the DPS_NotifyJobStatus Event is issued seven times in total from the PictBridge host protocol engine 34 to the PictBridge device protocol engine 14 (S29).

The PictBridge device protocol engine 14 compares the DPS_StartJob Request issued by itself to the contents of the DPS_NotifyJobStatus Event received from the PictBridge host protocol engine 34. In the comparison, the both sides do not coincide with each other, and it is confirmed that the printing result of the printing job in which the allocation of 100 images to one page is set (the number of the images in the first groups of images p is 100) is consequently divided into two pages with 80 images and 20 images in the respective pages. The DSC 10 (to be more specific, the PictBridge device protocol engine 14) judges that the maximum value of the number of the image objects to be set in the DPS_StartJob Request is 80 images (the maximum number of the images n that can be printed in each printing paper is 80) under the conditions in the printer 30: paper size=A4; and layout=index printing, and memorizes the judgment result in the memory 20 together with the paper size, layout, and the vendor name and the device name of the printer 30.

As a result, when the printing process is executed for the second time and thereafter under the same conditions as described above, the DSC 10 (PictBridge device protocol engine 14) references the contents memorized in the memory 20 to thereby judge that the DPS_StartJob Request in which the maximum value of the number of the images p in the object to be printed (first groups of images) that can be described in the single DPS_StartJob Request is set to 80 images and the number of all of the image objects (the number of the images m in the entire groups of images) recorded on the SD memory card 23 is set to 320 images should be issued four times (80 images+80 images+80 images+80 images=320 images in total), and then, issues the DPS_StartJob Request based on the judgment result.

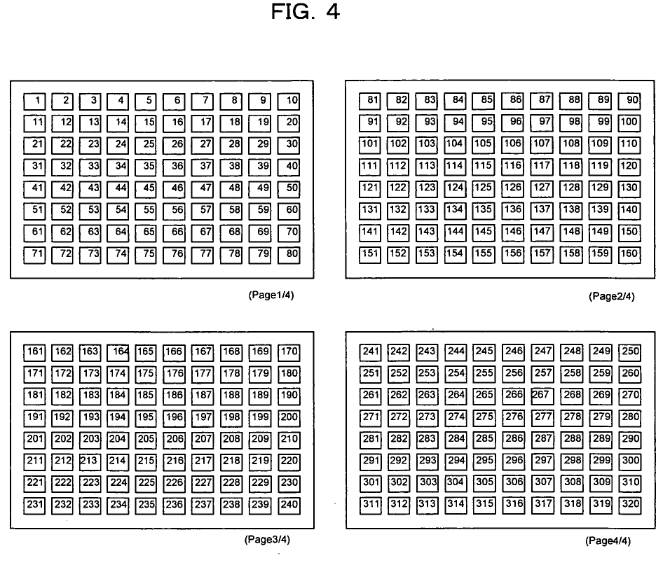

Thereby, the printing result of four pages (80 images+80 images+80 images+80 images) is obtained in the printer 30 as shown in FIG. 4, in which case the number of the images in the first groups of images p is 80, the number of the groups in the first groups of images q is four, the number of the images in the second group of images r is 0, and the number of the groups in the second group of images is 0.

As described, in the embodiment 1, the DSC 10 can optimize the printing layout by referencing the contents memorized in the memory 20 at the next time when the DPS_StartJob Request is issued.

Below is shown a constitution according to a modified embodiment of the embodiment 1. In the modified embodiment, the number of the images in the first groups of images p is changed to a maximum value p′ that satisfies the following expression.
p′=m/x
x is a natural number of at least 2
p′ satisfies p′<n

When the value p′ satisfying the foregoing expression does not exist, the number of the images in the first groups of images p is changed to the maximum number of the images to be printed per printing paper n which is set in the printer 30.

At the next time when the printing is instructed, the entire groups of images is divided into the first groups of images and the second group of images based on the changed maximum number of the images in the second group of images p′ or n.

Below is given a more detailed description based on a case where the PictBridge device protocol engine 14 judges the issuance of the DPS_StartJob Request in which the maximum value of the number of the images p on the object to be printed (the number of the images in the first group of images p) that can be described in the single DPS_StartJob Request is set to 100 images, the number of all of the image objects (the number of the images m in the entire groups of images) recorded on the SD memory card 23 is set to 180 images, and the maximum number of the images to be printed per printing paper n is set to 80.

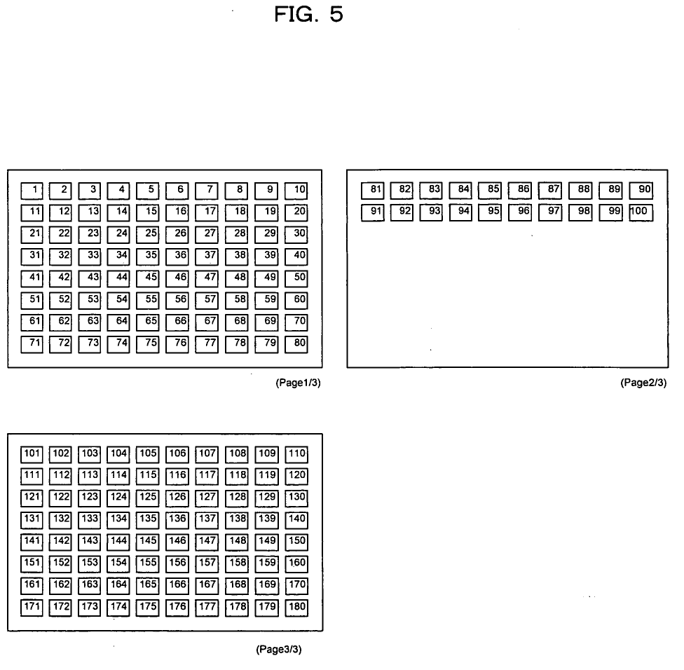

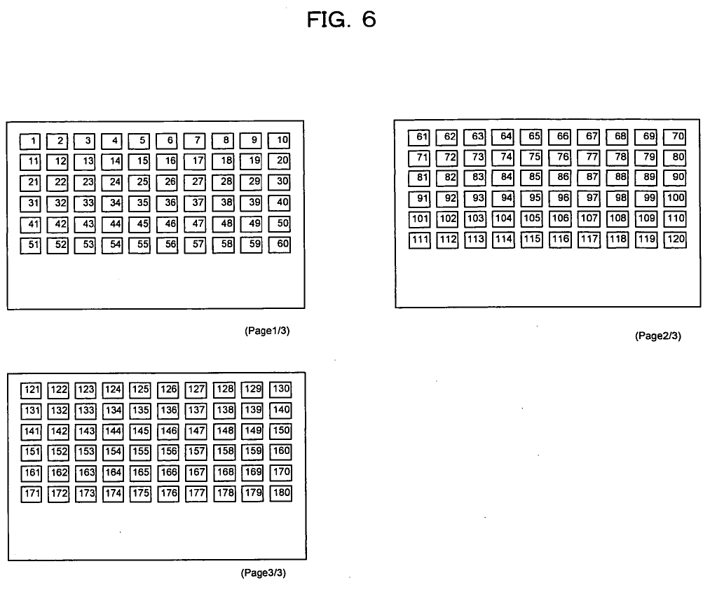

Provided that the DPS_StartJob Request reciting 100 image objects (the number of the images in the first groups of images p is 100) is requested by the DSC 10 with respect to the printer 30, the printer 30 takes each DPS_StartJob Request as a request for executing the printing job in a manner of dividing into two pages and executes the printing job (80 images in the first page, 20 images in the second page, 100 images in total). Therefore, the printing result of the foregoing entire-image index printing extends into three pages as shown in FIG. 5 (80 images in the first page, 20 images in the second page, 80 images in the third page).

The printing progress notice (DPS_NotifyJobStatus Event) at that time shows [first printing]: (Page 1/2, 80 images have been printed), [second printing]: (Page 2/2, 100 images have been printed) and [third printing]: (Page 1/1, 80 images have been printed). Accordingly, the DPS_NotifyJobStatus Event is issued three times in total from the PictBridge host protocol engine 34 to the PictBrdige device protocol engine 14 (S29).

The PictBridge device protocol engine 14 compares the DPS_StartJob Request issued by itself to the contents of the DPS_NotifyJobStatus Event received from the PictBridge host protocol engine 34. In the comparison, the both sides do not coincide with each other, and it is confirmed that the printing result with respect to the printing job in which the allocation of 100 images to one page is set (the number of the images in the first groups of images p is 100) has been divided into two pages with 80 images and 20 images in the respective pages. The DSC 10 (more specifically, PictBridge device protocol engine 14) then judges that the maximum value of the number of the image objects to be set in the DPS_StartJob Request is 80 images (the maximum number of the images n that can be printed in each printing paper is 80) under the conditions in the printer 30: paper size=A4; and layout=index printing, and memorizes the judgment result in the memory 20 together with the paper size, layout, and the vendor name and the device name of the printer 30.

As a result, when the printing process is executed for the second time and thereafter under the same conditions as described above, the DSC 10 (PictBrdige device protocol engine 14) references the contents memorized in the memory 20 to thereby select X=3 out of many natural numbers x of at least 2 that can divide the number of the images in the entire groups of images m (=180) without leaving any residue such as 2, 3, 4, 5, . . . so that the number of the images in the first groups of images p is at the maximum level, and adopts X=3. Then, the number of the images in the first groups of images p is 60, and the entire groups of images having the number of the entire images (m=180) can be printed in the equally spaced layout of 60 images per page×3.

When the printing process is executed for the second time and thereafter based on the set number of the images in the first groups of images p described above, the DSC 10 (PictBridge device protocol engine 14) references the contents memorized in the memory 20 to thereby judge that the DPS_StartJob Request in which the maximum value of the number of the images p in the object to be printed (first groups of images) that can be described in the single DPS_StartJob Request is set to 60 images and the number of all of the image objects (the number of the images m in the entire groups of images) recorded on the SD memory card 23 is set to 180 images should be issued three times (60 images+60 images+60 images=180 images in total), and then, issues the DPS_StartJob Request based on the judgment result.

As a result, the printer 30 executes the printing job of three pages (60 images+60 images+60 images). Accordingly, the printing layout can be optimized when the contents memorized in the memory 20 are referenced in the modified embodiment in the same manner as in the constitution of the embodiment 1.

In the embodiment 1 and the modified embodiment thereof described above, the memory 20 can memorize the number of the printing objects to be set in each printing job (the number of the images in the first groups of images m) with respect to the combinations (j×k combinations) of the vendor names or device names of the printer 30 of j number (j is a natural number of at least 1) of types and k number (k is a natural number of at least 1) of printing size and/or layout, however, may limitedly memorize the number of the objects to be printed in response to an optional i (i is a natural number of at least 1 and at most (j×k)) number of combinations out of the J×K combinations.

### Embodiment 2

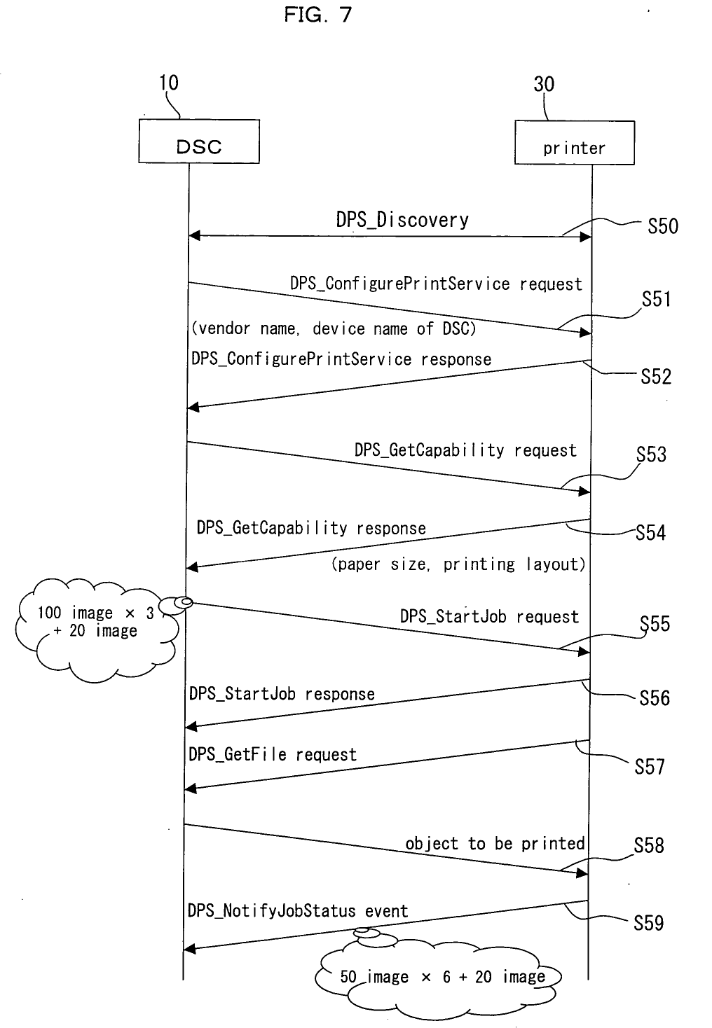

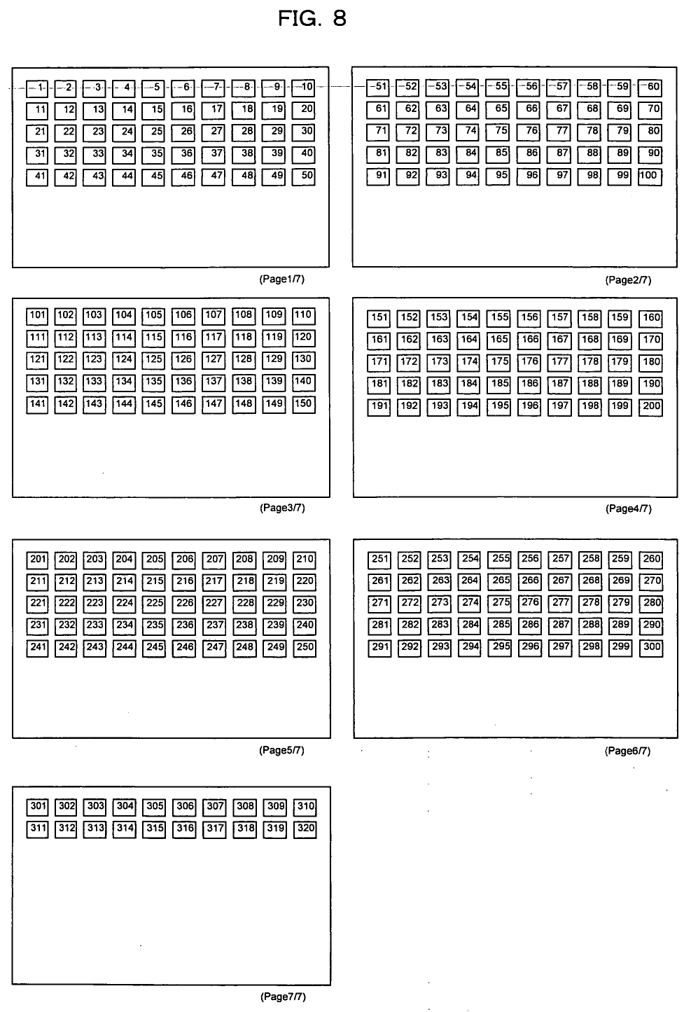

An embodiment 2 of the present invention is described referring to FIGS. 1, 7 and 8. FIG. 7 shows processing steps of the printing system according to the embodiment 2. The operation up to the establishment of the PictBridge protocol according to the present embodiment is the same as described in the embodiment 1 and, therefore, is not described here again.

When it is confirmed that the printer 30 and the DSC 10 are both the PictBridge-capable devices through the mutual confirmation (DPS_Discovery) (S50), the PictBridge device protocol engine 14 issues the activating command of the printing service (DPS_ConfigurePrintService Request) to the PictBridge host protocol engine 34 (S51). The vendor name and the device name of the DSC 10 are also notified in the DPS_ConfigurePrintService Request. The system controller 35 thereby acquires the vendor name and the device name of the DSC 10 and retains them in the memory 39.

The PictBridge host protocol engine 34 receives the DPS_ConfigurePrintService Request from the PictBridge device protocol engine 14 and correspondingly notifies the system controller 35 of the reception of the command. The system controller 35 makes an inquiry about the state of the printing hardware 40 via the printing hardware controller 37. Based on the inquiry, the printing hardware controller 37 queries the printing state of the printing hardware 40. When it is known from a result of the query that the printing hardware 40 is in the printable state, the system controller 35 notifies the PictBridge host protocol engine 34 of the offer of the printing service.

Upon the reception of the notice, the PictBridge host protocol engine 34 issues the DPS_ConfigurePrintService Response to the PictBridge device protocol engine 14 to thereby notify that the printing service is available (S52).

When the DPS_ConfigurePrintService Request—Response is completed, the PictBrdige device protocol engine 14 issues the printer capability acquiring command (DPS_GetCapability Request) to the PictBridge host protocol engine 34 (S53). Upon the reception of the DPS_GetCapability Request, the PictBridge host protocol engine 34 issues the DPS_GetCapability Response to the PictBridge device protocol engine 14 to thereby notify the information such as the paper size, printing layout and the like to be supported in accordance with the parameter of the request (S54).

In the embodiment 2, the printer 30 at least supports the paper size of A4, and further supports the index printing in which the maximum number of the images n that can be printed on each printing paper is set. The system controller 15 acquires the information from the PictBridge device protocol engine 14 and retains it in the memory 20.

When the DPS_GetCapability Request—Response is completed, the DSC 10 displays the printing menu screen on the LCD 24 in such manner that the capability of the printer 30 is reflected to thereby lead the user to perform the input operation. The user watches the printing menu screen displayed on the LCD 24 and operates the arrow key 25 to thereby select the printing process. In the embodiment 2, the entire-image index printing is executed on the A4 sheet of paper in the same manner as in described in the embodiment 1.

When the entire-image index printing is executed in the DSC 10 based on the user's input operation, the PictBridge device protocol engine 14 issues the printing job issuing command (DPS_StartJob Request) to the PictBridge host protocol engine 34 (S55).

At that time, the PictBridge device protocol engine 14 should describe all of the images recorded on the SD memory card 23 together with the paper size (A4) and the printing layout (index printing) on the object to be printed as the parameter to be described in the DPS_StartJob Request. However, the restrictions of the memory and the like impose the upper limit on the size of the DPS_StartJob Request. Therefore, when it is not possible to describe all of the mages in the single DPS_StartJob Request, the single DPS_StartJob Request is issued a plurality of times so that the images recorded on the SD memory card 23 can be subjected to the index printing.

More specifically, in the same manner as described in the embodiment 1, the PictBridge device protocol engine 14 outputs the printing instruction (DPS_StartJob Request) for dividing the entire groups of images including the m number of images defined in the following expression (all of the images recorded on the SD memory card 23) into the first groups of images having the p number of images and the q number of groups and the second group of images having the r number of images and one or none group and printing the respective divided images on the each printing paper to the PictBridge Host protocol engine 34.
m=p*q+r*s
p is a natural number not including 0
r satisfies p>r
s=0 or 1
q, r are natural numbers including 0

In the embodiment 2, in the same manner as described in the embodiment 1, the PictBridge device protocol engine 14 sets the maximum value of the number of the printing objects (the number of the images in the first groups of images p) that can be described in the single DPS_StartJob Request to 100 images, and sets the number of all of the image objects (the number of the images in the entire groups of images m) recorded on the SD memory card 23 to 320 images. In order to realize the entire-image index printing in the foregoing example, the DPS_StartJob Request is issued four times (100 images+100 images+100 images+20 images=320 images in total). Then, the number of the images in the first groups of images p is 100, the number of the groups in the first groups of images q is 3, the number of the images in the second group of images r is 20, and the number of the groups in the second group of images is 1.

The PictBridge host protocol engine 34 of the printer 30, in response to the reception of the DPS_StartJob Request from the DSC 10, analyzes the contents of the request and issues the DPS_StartJob Response to the PictBridge device protocol engine 14 of the DSC 10 (S56). Further, the PictBridge host protocol engine 34 issues the DPS_GetFile Request to the PictBridge device protocol engine 14 (S57) to thereby acquire the image object to be printed from the DSC 10 (S58).

Provided that the maximum number of the images n (n is a natural number of at least 1) allocated to each printing paper by the printer 30 is 80 (80 images per page) and a minimum number of images z (z is a natural number of at least 1) is 40 (40 images per page) in the case where the printing type (layout) is the index printing and the paper size in the printer 30 is A4, when, for example, the DPS_StartJob Request in which 100 image objects (the number of the images in the first groups of images p is 100) are described is made to the printer 30 from the DSC 10, a conventional printer executes the printing job in a manner of dividing into two pages (80 images in the first page, 20 images in the second page, 100 images in total). Therefore, the printing result obtained in the foregoing entire-image index printing, as shown in FIG. 3, extends into seven pages (80 images in the first page, 20 images in the second page, 80 images in the third page, 20 images in the fourth page, 80 images in the fifth page, 20 images in the sixth page, 20 images in the seventh page).

In contrast to that, in the embodiment 2 of the present invention, the PictBridge host protocol engine 34 compares the numeral value 100 of the image objects (the number of the images in the first groups of images p) set in each DPS_StartJob Request to the numeral value 80 of the maximum value of the number of the images to be allocated in the printer 30 (the maximum number of the images n to be allocated to each printing paper), and confirms that they do not coincide with each other and the numeral value 100 of the image objects (the number of the images in the first groups of images p) in each DPS_StartJob Request is larger than the maximum value of the number of the images to be allocated in the printer 30 (the maximum number of the images n to be allocated to each printing paper) (p>n). Then, the PictBridge host protocol engine 34 resets the maximum value of the number of the images to be allocated in the printer 30 (the maximum number of the images n in each printing paper) to a maximum value of a natural number n′ that satisfies the following expression (1).
n′=p/x (1)
z<=n′<=n
n′<=n
x is a natural number of at least 2
z is a minimum number of images to be allocated to each printing paper (a natural number of at least 1) defined by the printing server

When the maximum value of the natural number n′ satisfying the expression (1) does not exist, the following expression (2) or (3) is set in place of the expression (1). In the expression (2), the maximum value of the natural number n′ satisfying the expression (2) or (3) is found.
n′=(p+y)/x (2)
z<=n′<=n
x is a natural number of at least 2
y is a natural number of at least 1 and below n′
z is a minimum number of images to be allocated to each printing paper (a natural number of at least 1) defined by the printing server
   n′=(p−y)/x (3)
z<=n′<=n
x is a natural number of at least 2
y is a natural number of at least 1 and below n-n′
z is a minimum number of images to be allocated to each printing paper (a natural number of at least 1) defined by the printing server

In the example shown here, the expression (1) is materialized, and value 50 is singly found as n′. Based on the obtained result, the PictBridge host protocol engine 34 sets the maximum value of the number of the images to be allocated in the printer 30 (the maximum number of the images n′ to be allocated to each printing paper) to 50 which is a half of the initial value (100).

When the foregoing expression (1) is not materialized, in other words, the numeral value of the image objects per DPS_StartJob Request (the number of the images in the first groups of images p) cannot be divided by the maximum value of the images to be allocated in the printer 30 (the maximum number of the images n to be allocated to each printing paper), the PictBridge host protocol engine 34 sets the maximum value of the number of the images to be allocated in the printer 30 (the maximum number of the images n′ to be allocated in each printing paper) based on the aforementioned expression (2) or (3).

First, the value 1 is assigned to the expression (2) or (3) as the value of y so as to judge whether or not n′ satisfying the expression (2) or (3) exists. If n′ satisfying the expression (2) or (3)is singly found at this stage, the PictBridge host protocol engine 34 sets the found n′ as the maximum value of the number of the images to be allocated in the printer 30 (the maximum number of the images to be allocated in each printing paper n′). If more than one n′ satisfying the expression (2) or (3) is found at this stage, the PictBridge host protocol engine 34 sets a maximum value of the plurality of n's as n′.

When the expressions (1), (2) and (3) are used in the combined manner, the number of the image objects for each DPS_StartJob Request (the number of the images in the first groups of images p) can all be handled. It is possible that the n′ satisfying any of the expressions (1), (2) and (3) cannot be found depending on the value of the minimum number of the images z set by the printing server. In such a case, it is judged that the printing result of the printing process cannot be optimized without being based on the maximum number of the images n. Then, the printing process based on the maximum number of the images n as the default value is executed.

As a result of the process described above, the printing result of the entire-image index printing extends into seven pages (50 images in the first page, 50 images in the second page, 50 images in the third page, 50 images in the fourth page, 50 images in the fifth page, 50 images in the sixth page, 20 images in the seventh page). Then, a printing quality in the printing result can be improved in comparison to the operation in the unique manner solely based on the maximum value of the number of the images to be allocated in the printer 30 (the maximum number of the images n allocated to each printing paper (80 images in the first page, 20 images in the second page, 80 images in the third page, 20 images in the fourth page, 80 images in the fifth page, 20 images in the sixth page, 20 images in the seventh page).

### Embodiment 3

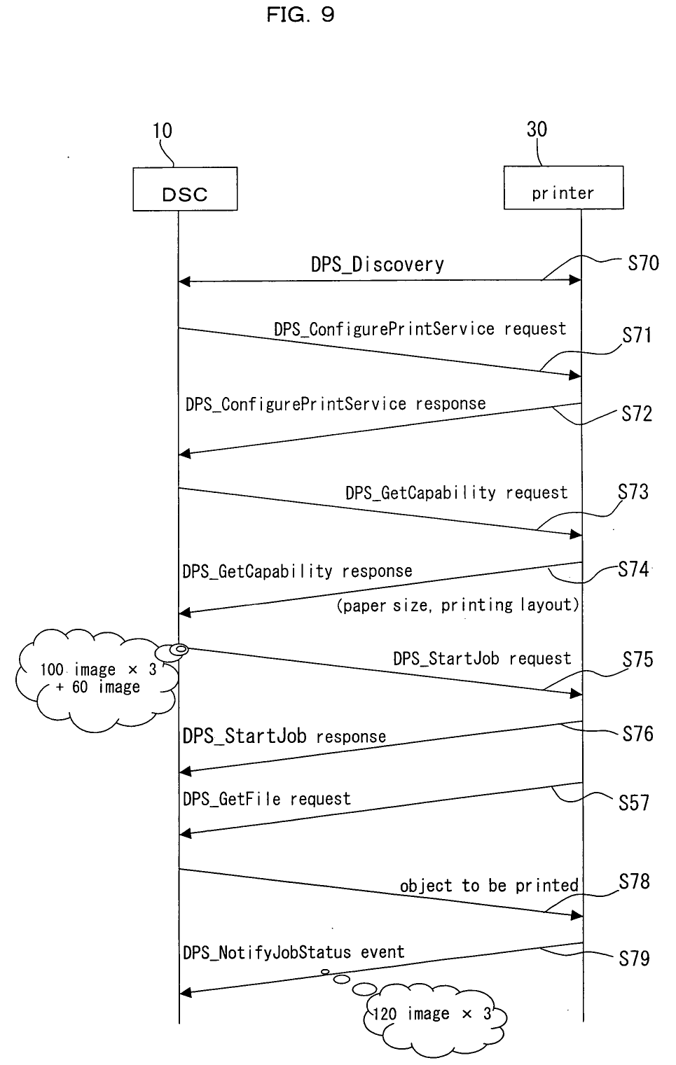

An embodiment 3 of the present invention is described referring to FIGS. 1 and 9-11. FIG. 9 shows processing steps of the printing system according to the embodiment 3. The operation up to the establishment of the PictBridge protocol according to the present embodiment is the same as described in the embodiment 1 and, therefore, is not described here again.

When the mutual confirmation (DPS_Discovery) that the printer 30 and the DSC 10 are both the PictBridge-capable devices is completed (S70), the PictBridge device protocol engine 14 issues the activating command of the printing service (DPS_ConfigurePrintService Request) to the PictBridge host protocol engine 34 (S71).

Upon the reception of the DPS_ConfigurePrintService Request, the PictBridge host protocol engine 34 notifies the system controller 35 of the reception of the command. The system controller 35 makes an inquiry about the state of the printing hardware 40 via the printing hardware controller 37. When it is known from the inquiry that the printing hardware 40 is in the printable state, the system controller 35 notifies the PictBridge host protocol engine 34 of the offer of the printing service.

Upon the reception of the notice, the PictBridge host protocol engine 34 issues the DPS_ConfigurePrintService Response to the PictBridge device protocol engine 14 to thereby notify that the printing service is available (S72).

When the DPS_ConfigurePrintService Request—Response is completed, the PictBrdige device protocol engine 14 issues the printer capability acquiring command (DPS_GetCapability Request) to the PictBridge host protocol engine 34 (S73). Upon the reception of the DPS_GetCapability Request, the PictBridge host protocol engine 34 issues the DPS_GetCapability Response to the PictBridge device protocol engine 14 to thereby notify the information such as the paper size, printing layout and the like to be supported in accordance with the parameter of the request (S74).

In the embodiment 3, the printer 30 at least supports the paper size of A4, and further supports the index printing in which the maximum number of the images n that can be printed on each printing paper is set. The system controller 15 acquires the information from the PictBridge device protocol engine 14 and retains it in the memory 20.

When the DPS_GetCapability Request—Response is completed, the DSC 10 displays the printing menu screen on the LCD 24 in such manner that the capability of the printer 30 is reflected to thereby lead the user to perform the input operation. The user watches the printing menu screen displayed on the LCD 24 and operates the arrow key 25 to thereby select the printing process. In the embodiment 3, the entire-image index printing is executed on the A4 sheet of paper.

When the entire-image index printing is executed in the DSC 10 based on the user's input operation, the PictBridge device protocol engine 14 issues the printing job issuing command (DPS_StartJob Request) to the PictBridge host protocol engine 34 (S75).

At that time, the PictBridge device protocol engine 14 should describe all of the images recorded on the SD memory card 23 together with the paper size (A4) and the printing layout (index printing) on the object to be printed as the parameter to be described in the DPS_StartJob Request. However, the restrictions of the memory and the like impose the upper limit on the size of the DPS_StartJob Request. Therefore, when it is not possible to describe all of the images in the single DPS_StartJob Request, the single DPS_StartJob Request is issued a plurality of times so that the index printing of all of the images recorded on the SD memory card 23 can be realized.

More specifically, the PictBridge device protocol engine 14 outputs the printing instruction (DPS_StartJob Request) for dividing the entire groups of images including the m number of images defined in the following expression (all of the images recorded on the SD memory card) into the first groups of images having the p number of images and the q number of groups and the second group of images having the r number of images and one or none group and printing the respective divided images on the each printing paper to the PictBridge Host protocol engine 34.
m=p*q+r*s
p is a natural number not including 0
r satisfies p>r
s=0 or 1
q, r are natural numbers including 0

In the embodiment 3, the PictBridge device protocol engine 14 sets the maximum value of the number of the images (the number of the images in the first groups of images p) in the object to be printed that can be described in the single DPS_StartJob Request to 100 images, and sets the number of the all of the image objects (the number of the images in the entire groups of images m) recorded on the SD memory card 23 to 360 images. In order to realize the entire-image index printing in the foregoing example, the DPS_StartJob Request is issued four times (100 images+100 images+100 images+60 images=360 images in total). Then, the number of the images in the first groups of images p is 100, the number of the groups in the first groups of images q is 3, the number of the images in the second group of images r is 60, and the number of the groups in the second group of images s is 1.

The PictBridge host protocol engine 34 of the printer 30, in response to the reception of the DPS_StartJob Request from the DSC 10, analyzes the contents of the request and issues the DPS_StartJob Response to the PictBridge device protocol engine 14 of the DSC 10 (S76). Further, the PictBridge host protocol engine 34 issues the DPS_GetFile Request to the PictBridge device protocol engine 14 (S77) to thereby acquire the image object to be printed from the DSC 10 (S78).

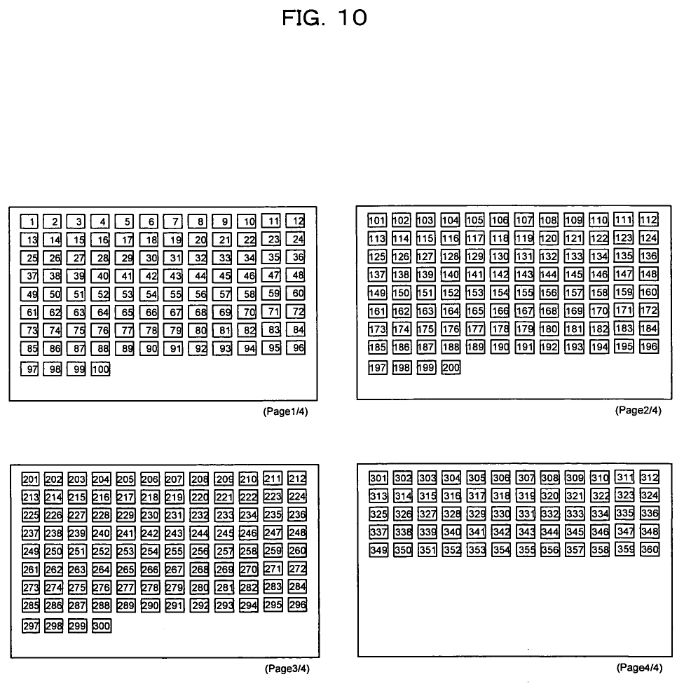

Provided that the maximum number of the images n (n is a natural number of at least 1) allocated to each printing paper by the printer 30 is 120 (120 images per page) in the case where the printing type (layout) is the index printing and the paper size in the printer 30 is A4, when the DPS_StartJob Request in which 100 image objects (the number of the images in the first groups of images p is 100) are described is made to the printer 30 from the DSC 10, and the printer 30 prints the entity of the DPS_StartJob Request into four pages with 100 images, 100 images, 100 images and 60 images on the respective pages based on the request as shown in FIG. 10.

In contrast, in the embodiment 3, a correlation between the current DPS_StartJob Request and the subsequent DPS_StartJob Request is judged in the PictBridge host protocol engine 34. More specifically, the PictBridge host protocol engine 34 compares the number of the images in the first groups of images p set in the DPS_StartJob Request (printing instruction) received from the DSC 10 to the maximum number of the images per printing paper n set in the printer 30. When it is judged that the number of the images p is smaller than the maximum number of the images n (p<n), the PictBridge host protocol engine 34 sums the continuous first groups of images or sums the first group of images and the second group of images continuous therefrom in the entire groups of images having the m number of images (360) and collectively prints the summing result.

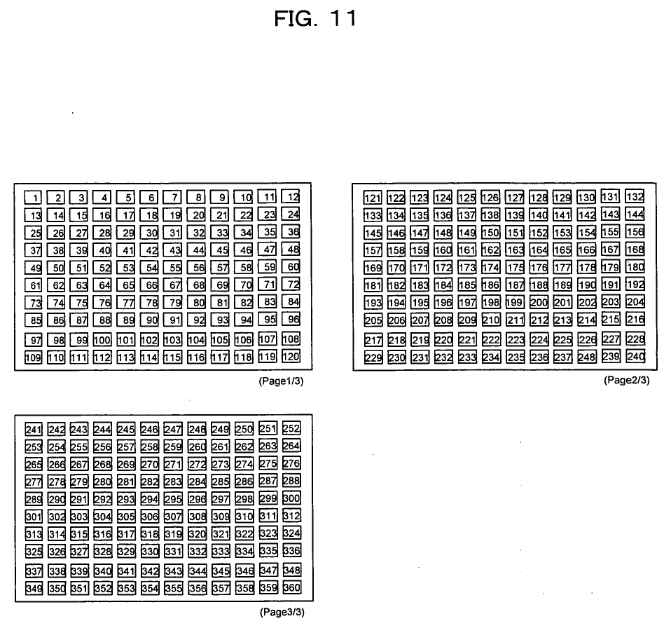

More specifically, as shown in FIG. 11, the images constituting the respective groups of images are summed until the summation reaches the maximum number of the images per printing paper n (120) set in the printer 30 in the continuous first groups of images and the first group of images and the second group of images continuous therefrom in the entire groups of images comprising the 360 images, and then, the summed groups of images are printed. Any image as a remainder generated from the summing process is added to the images constituting the subsequent first group of images or the images constituting the subsequent second group of images and printed. Any image as a remainder generated from the summing process in the second group of images is independently printed because the second group of images is not followed by any group of images.

In the embodiment 3 described above, the printing result of the entire-image index printing extends into three pages (120 images in the first page, 120 images in the second page, and 120 images in the third page), wherein the images can be printed in such manner that the image allocating capability of the printer 30 can be maximally exploited.

### Embodiment 4

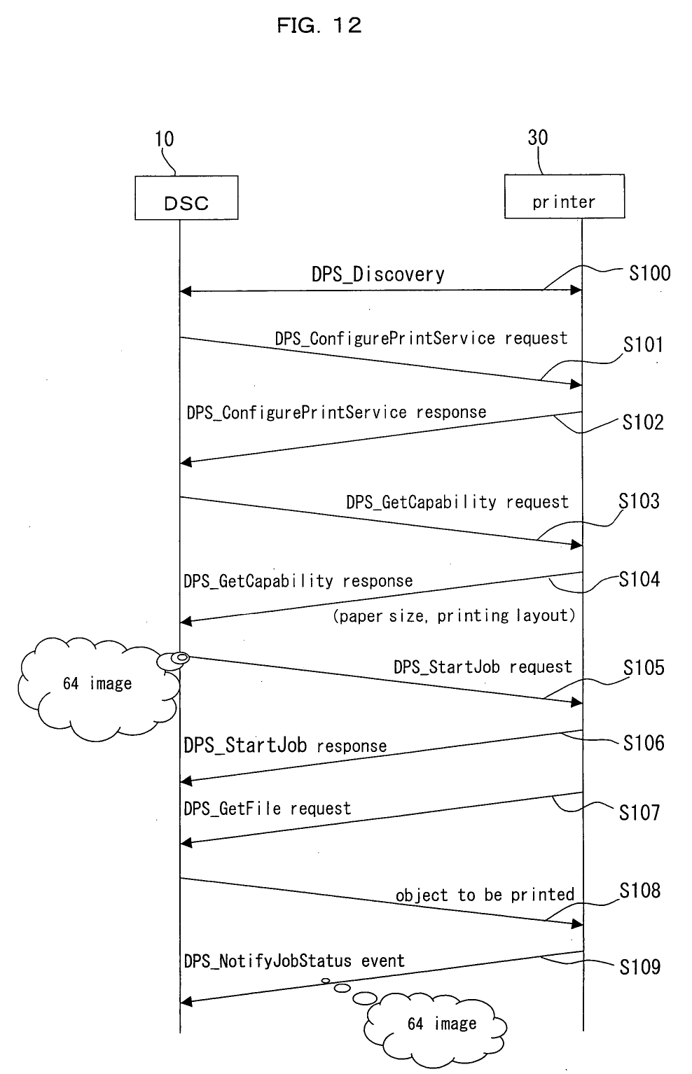

An embodiment 4 of the present invention is described referring to FIGS. 1, 12-14. FIG. 12 shows processing steps of the printing system according to the embodiment 4. The operation up to the establishment of the PictBridge protocol according to the present embodiment is the same as described in the embodiment 1 and, therefore, is not described here again.

When the mutual confirmation (DPS_Discovery) that the printer 30 and the DSC 10 are both the PictBridge-capable devices is completed (S100), the PictBridge device protocol engine 14 issues the activating command of the printing service (DPS_ConfigurePrintService Request) to the PictBridge host protocol engine 34 (S101). The vendor name and device name of the DSC 10 are included in the contents of the DPS_ConfigurePrintService Request.

Upon the reception of the DPS_ConfigurePrintService Request, the system controller 35 acquires the vendor name and the device name from the PictBridge host protocol engine 34 and retains them in the memory 39. The PictBridge host protocol engine 34, upon the reception of the DPS_ConfigurePrintService Request, notifies the system controller 35 of the reception of the command. The system controller 35 makes an inquiry about the state of the printing hardware 40 via the printing hardware controller 37. When it is known that the printing hardware 40 is in the printable state, the system controller 35 notifies the PictBridge host protocol engine 34 of the offer of the printing service.

Upon the reception of the notice, the PictBridge host protocol engine 34 issues the DPS_ConfigurePrintService Response to the PictBridge device protocol engine 14 to thereby notify that the printing service is available (S102).

When the DPS_ConfigurePrintService Request—Response is completed, the PictBrdige device protocol engine 14 issues the printer capability acquiring command (DPS_GetCapability Request) to the PictBridge host protocol engine 34 (S103). Upon the reception of the DPS_GetCapability Request, the PictBridge host protocol engine 34 issues the DPS_GetCapability Response to the PictBridge device protocol engine 14 to thereby notify the information such as the paper size, printing layout and the like to be supported in accordance with the parameter of the request (S104).

In the embodiment 4, the printer 30 at least supports the paper size of A4, and further supports the index printing in which the maximum number of the images n that can be printed on each printing paper is set. The system controller 15 acquires the information from the PictBridge device protocol engine 14 and retains it in the memory 20.

When the DPS_GetCapability Request—Response is completed, the DSC 10 displays the printing menu screen on the LCD 24 in such manner that the capability of the printer 30 is reflected to thereby lead the user to perform the input operation. The user watches the printing menu screen displayed on the LCD 24 and operates the arrow key 25 to thereby select the printing process. In the embodiment 4, the entire-image index printing is executed on the A4 sheet of paper in the same manner.

When the entire-image index printing is executed in the DSC 10 based on the user's input operation, the PictBridge device protocol engine 14 issues the printing job issuing command (DPS_StartJob Request) to the PictBridge host protocol engine 34 (S105).

At that time, the PictBridge device protocol engine 14 should describe all of the images recorded on the SD memory card 23 together with the paper size (A4) and the printing layout (index printing) on the object to be printed as the parameter to be described in the DPS_StartJob Request. However, the restrictions of the memory and the like impose the upper limit on the size of the DPS_StartJob Request. Therefore, when it is not possible to describe all of the images in the single DPS_StartJob Request, the single DPS_StartJob Request is issued a plurality of times so that the index printing of all of the images recorded on the SD memory card 23 can be realized.

More specifically, the PictBridge device protocol engine 14 outputs the printing instruction (DPS_StartJob Request) for dividing the entire groups of images including the m number of images defined in the following expression (all of the images recorded on the SD memory card) into the first groups of images having the p number of images and the q number of groups and the second group of images having the r number of images and one or none group and printing the respective divided images on the each printing paper to the PictBridge Host protocol engine 34.
m=p*q+r*s
p is a natural number not including 0
r satisfies p>r
s=0 or 1
q, r are natural numbers including 0

In the embodiment 4, the PictBridge device protocol engine 14 sets the maximum value of the number of the images (the number of the images in the first groups of images p) in the object to be printed that can be described in the single DPS_StartJob Request to 100 images, and sets the number of all of the image objects (the number of the images in the entire groups of images m) recorded on the SD memory card 23 to 64 images. In order to realize the entire-image index printing in the foregoing example, the DPS_StartJob Request is issued once (64 images in total). Then, the number of the images in the first groups of images p is 64, the number of the groups in the first groups of images q is 1, the number of the images in the second group of images r is 0, and the number of the groups in the second group of images is 0.

The PictBridge host protocol engine 34 of the printer 30, in response to the reception of the DPS_StartJob Request from the DSC 10, analyzes the contents of the request and issues the DPS_StartJob Response to the PictBridge device protocol engine 14 of the DSC 10 (S106). Further, the PictBridge host protocol engine 34 issues the DPS_GetFile Request to the PictBridge device protocol engine 14 (S107) to thereby acquire the image object to be printed from the DSC 10 (S108).

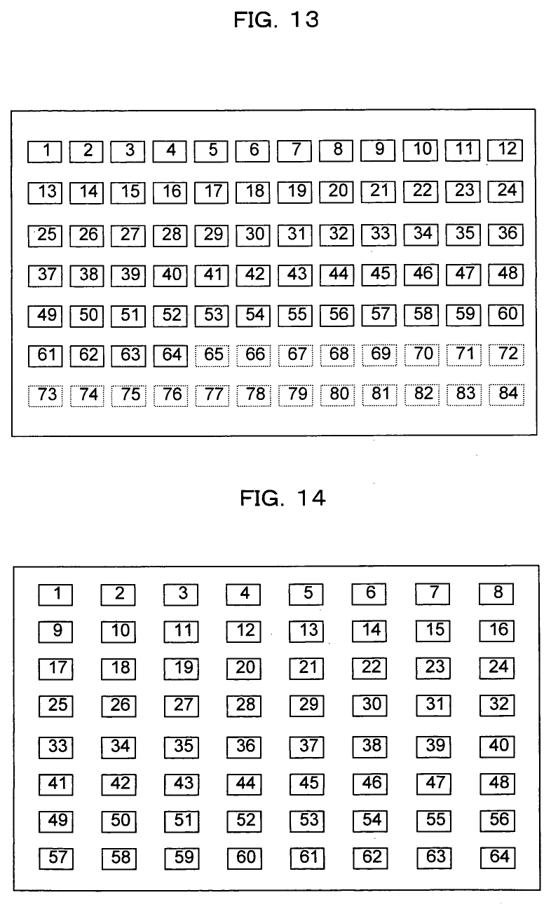

Provided that the maximum number of the images n (n is a natural number of at least 1) allocated to each printing paper by the printer 30 is 84 (12 images×8 lines=84 images per page) in the case where the printing type (layout) is the index printing and the paper size in the printer 30 is A4, when the layout of 12 images×6 lines is directly applied to the printing of 64 images, the printing result of 12 images×5 lines+fractional 4 images is obtained as shown in FIG. 13.

Accordingly, in the embodiment 4, the correlation between the number of the images to be printed described in the DPS_StartJob Request and the maximum number of the images to be allocated to the printing paper by the printer 30 is judged in the PictBridge host protocol engine 34. More specifically, the PictBridge host protocol engine 34 compares the number of the image in the entire groups of images m set in the DPS_StartJob Request (printing instruction) received from the DSC 10 to the maximum number of the images per printing paper n set in the printer 30. When the number of the images m is smaller than the maximum number of the images n (m<n), instead of adopting the default maximum number of the images n=84, n=p*q=12 images×8 lines for the layout of the allocation to the printing paper, n′, p′ and q′ each having a minimum difference relative to the number of the images m=64 and satisfying n′=p′*q′, m<=n′<=n, p′<=p, and q′<=q are calculated, and the layout is dynamically changed to p′ images×q′ lines. Then, the printing process is executed. Because the number of the images m=64, when 64 is factorized into prime numbers, a result thereby obtained is 2ˆ6 (the 6th power of 2). Further, when p′ and q′ satisfying the foregoing conditions are searched provided that n′=64, a result thereby obtained is that the foregoing conditions are materialized in the combination of p′=8 and q′=8. According to the embodiment 4, based on the obtained results, the layout is dynamically changed from 12 images×8 lines to 8 images×8 lines and evenly disposed and printed on the printing paper.

Therefore, the printing result of the entire-image index printing in the foregoing case is 64 images (8 images×8 lines) wherein the printing layout in which a blanc space is minimally allocated in the effective image allocation region per the printing paper is obtained. Therefore, the layout quality in the printing result can be improved in comparison to the operation in the unique manner (12 images×5 lines+fractional 4 images) solely based on the maximum number of the images to be allocated in the printer 30 (72 images (12 images×6 lines))

The present embodiment described the case where n′, p′ and q′ satisfying the conditions were uniquely determined. However, there may be a plurality of combinations satisfying the conditions depending on a combination of m, n, p and q. A thought is given to a case where the number of the images m in the embodiment 4 is m=72. First, when the number of the images m is factorized into prime numbers, a result thereby obtained is 2ˆ3*3ˆ2. When p′ and q′ satisfying the foregoing conditions are searched provided that n′=72, two combinations of p′=9, q′=8 and p′=12, q′=6 are obtained. A few examples where the layout is uniquely determined from the plurality of combinations are described below. As a first example, a priority is previously set in the number of the images p′ in the horizontal direction and the number of the images q′ in the vertical direction, and the values which minimize a difference between the prioritized number of the images p′ or q′ and the default number of the images p or q are selected. More specifically, when the priority is set in the number of the images p′ in the horizontal direction, p′=12, q′=6 are selected. When the priority is set in the number of the images q′ in the vertical direction, p′=9, q′=8 are selected. As a second example, instead of setting the priority in the numbers of the images in the horizontal and vertical directions, p′ and q′ which minimize a sum of the difference in the numbers of the images in the vertical directions (p-p′) and the difference in the numbers of the images in the horizontal directions (q-q′) are selected. In the foregoing combinations, when p′=9, q′=8, (p-p′)+(q-q′)=(12-9)+(8-8)=3, and when p′=12, q′=6, (12-12)+(8-6)=2, as a result, p′=12, q′=6 are selected. As another example, the plurality of combinations may be displayed on UI as a selectable layout list so as to lead the user to make a choice. In that case, a selection screen showing [9 columns×8 lines]/[12 columns×6 lines] is displayed on the UI, and the printing process is executed in accordance with the layout selected by the user is executed.

The present embodiment described the case where the number of the images m could be factorized into prime numbers, however, as a matter of fact, the number of the images m may not be factorized into prime numbers in some cases (m=prime number). A thought is given to a case where the number of the images m in the embodiment 4 is m=71. The number of the images m is a prime number and therefore cannot be factorized into prime numbers. Then, n′, p′ and q′ each having a minimum difference relative to the number of the images m and satisfying n′=p′*q′, m<=n′<=n, p′<=p, q′<=q are calculated. More specifically, n′ is serially increased by one in the range between m+1 and n and evaluated, and n′, p′ and q′ that are first found are adopted. When m=71, 71+1=72. Then, n′=72, and accordingly, n′, p′ and q′ satisfying the conditions (n′=72, p′=9, q′=8, or p′=12, q′=6) are calculated. The exemplary method of uniquely selecting the layout from the plurality of combinations satisfying the conditions is as described earlier.

In the embodiments 1-4, the operation according to the present invention is realized through the interaction between the DSC 10 and the printer 30. However, in the embodiment 1, the present invention can be applied to a device comprising only the DSC 10 because the interaction described in the embodiment 1 can be established when the DSC 10 is connected to a conventional PictBridge-capable printer for the operation.

In the same manner, in the embodiments 2-4, the present invention can be applied to a device comprising only a block corresponding to the printer 30 because the interactions described in the embodiments 2-4 can be established when the printer 30 is connected to the conventional PictBridge-capable DSC for the operation.

The printing hardware 40 described in the embodiments comprises only the printing function, however, may further comprise a display device for technically displaying the printing state. The printing hardware 40 may comprise only the display device for displaying the printing state in a pseudo-manner.

While there has been described what is at present considered to be preferred embodiments of this invention, it will be understood that various modifications may be made therein, and it is intended to cover in the appended claims all such modifications as fall within the true spirit and scope of this invention.

What is claimed is:

1. A printing client connected to a printing server for executing a printing process in which a maximum n number (n is a natural number of at least 1) of images on each printing paper are printed in such manner that an intercommunication therebetween is allowed, the printing client being notified of a printing state of the printing process by the printing server, wherein
the printing client outputs a printing instruction for dividing entire groups of images including m number of images defined in the following expression into first groups of images having p number of images and q number of groups and a second group of images having r number of images and one or none group to the printing server,
m=p*q+r*s
p is a natural number not including 0
r satisfies p>r
q, r are natural numbers including 0,
s=0 or 1
and the printing client further calculated the maximum number of the images n for the each printing paper from the printing state notified by the printing server and changes the number of the images in the first groups of images p based on the comparison of the maximum number of the images n to the number of the images in the first groups of images p set in the printing client and divides the entire groups of images into the first groups of images and the second group of images based on a changed number of images in the first groups of images p′ at a next time when the printing instruction is issued.

2. A printing client as claimed in claim 1, wherein
when the maximum number of the images n for the each printing paper described in the printing state notified by the printing server and the number of the images in the first groups of images p set in the printing client do not coincide with each other, the printing client changes the number of the images in the first group of images from p to p′ (=n), and
the printing client divides the entire groups of images into the first groups of images and the second group of images based on the changed maximum number of the images in the first groups of images n at a next time when the printing instruction is issued.

3. A printing client as claimed in claim 1, wherein
when the maximum number of the images n for the each printing paper described in the printing state notified by the printing server and the number of the images in the first groups of images p set in the printing client do not coincide with each other, the printing client changes the number of the images in the first group of images p to a maximum value of p′ satisfying the following expression (1) at a next time when the printing instruction is issued,
p′=m/x (1)
x is a natural number of at least 2
p′ satisfies p′<n
the printing client changes the number of the images in the first groups of images from the p to p′ (=n) when the value p′ satisfying the expression (1) does not exist, and
the printing client divides the entire groups of images into the first groups of images and the second group of images based on the changed maximum numbers of the images in the first groups of images p′ and n at a next time when the printing instruction is issued.

4. A printing client as claimed in claim 1, wherein
the printing client memorizes the changed maximum number of the images in the first groups of images p′ per the printing server in association with at least each printing paper size

5. A printing server connected to a printing client for outputting a printing instruction for dividing entire groups of images including m number of images defined in the following expression into first groups of images having p number of images and q number of groups and a second group of images having r number of images and one or none group and printing the respective divided images on each printing paper in such manner that an intercommunication therebetween is allowed, the printing server further executing a printing process in which n number of images (n is a natural number of at least 1) are printed per the printing paper based on the printing instruction,
m=p*q+r*s
p is a natural number not including 0
r satisfies p>r
q, r are natural numbers including 0
s=0 or 1
wherein the printing server dynamically sets number of images to be printed on the each printing paper n′ (n′<=n) based on the printing instruction received from the printing client and executes the printing process.

6. A printing server as claimed in claim 5, wherein
when the number of the images in the first groups of images p set in the printing instruction received from the printing client is larger than the maximum number of the images n per the printing paper (p>n), the printing process is executed after the number of the images n′ (n′<=n) on each printing paper is dynamically set so that a variation in number of images to be printed per the printing paper in printing the number p of images can be minimum between the printing papers.

7. A printing server as claimed in claim 6, wherein
when the number of the images in the first groups of images p set in the printing instruction received from the printing client is larger than the maximum number of the images n per the printing paper (p>n), the printing process is executed after the maximum number of the images n per the printing paper is changed to a maximum value of a natural number n′ satisfying the following expression,
n′=p/x (1)
z<=n′<=n
x is a natural number of at least 2
z is a minimum number of images to be allocated to each printing paper (a natural number of at least 1) defined by the printing server.

8. A printing server as claimed in claim 7, wherein
the following expression (2) or (3) is set in place of the expression (1) when the natural number n′ satisfying the expression (1) does not exist so that the maximum value of the natural number n′ satisfying the expression (2) or (3) can be found,
n′=(p+y)/x (2)
z<=n′<=n
x is a natural number of at least 2
y is a natural number of at least 1 and below n′
z is a minimum number of images to be allocated to each printing paper (a natural number of at least 1) defined by the printing server
n′=(p−y)/x (3)
z<=n′<=n
x is a natural number of at least 2
y is a natural number of at least 1 and below n-n′
z is a minimum number of images to be allocated to each printing paper (a natural number of at least 1) defined by the printing server.

9. A printing server as claimed in claim 5, wherein
the continuous printing instructions are summed, and the number of the images per the printing paper is collectively printed based on the maximum number of the images n.

10. A printing server as claimed in claim 5, wherein
when the number of the images in the entire groups of images m set in the printing instruction received from the printing client is smaller than the maximum number of the images n per the printing paper set in the printing server (m<n), number of images n′ per the printing paper, number of images p′ in a horizontal direction per the printing paper and number of images q′ in a vertical direction per the printing paper, which minimizes a difference between the maximum number of the images n (satisfying n=p*q (p, q are natural numbers of at least 1) and the number of the images m in the entire groups of images, are calculated,
n′=p′*q′ (p, q are natural numbers of at least 1)
m<=n′<=n
p′<=p
q′<=q,
and the number of the images m in the entire groups of images is allocated to the each printing paper by p′ image in the horizontal direction and q′ image in the vertical direction and thereby evenly disposed and printed on the printing paper.

11. A printing server as claimed in claim 5, wherein
the printing process includes a display process of a printing image on the each printing paper or is replaced by the display process.
